(19) United States
(12) Patent Application Publication
(10) Pub. No.: US 2018/0043859 A1
(43) Pub. Date: Feb. 15, 2018

(54) PRETENSIONER, RETRACTOR AND SEAT BELT DEVICE

(71) Applicant: TAKATA CORPORATION, Tokyo (JP)

(72) Inventors: Hirokazu Yoshioka, Echi-gun (JP); Kiyoshi Watanabe, Echi-gun (JP); Hayato Usui, Echi-gun (JP)

(73) Assignee: TAKATA CORPORATION, Tokyo (JP)

(21) Appl. No.: 15/670,898

(22) Filed: Aug. 7, 2017

(30) Foreign Application Priority Data
Aug. 10, 2016 (JP) 2016-157180

(51) Int. Cl. B60R 22/46

(52) U.S. Cl. CPC B60R 22/4628; B60R 2022/3402

(57) ABSTRACT

A pretensioner includes a driving wheel and a power transmission unit. A spool is disposed to be rotatable in the driving wheel. The spool winds a webbing which restrains an occupant. The power transmission unit transmits power to the driving wheel during an emergency. The power transmission unit includes a resin-made long body, a pipe and a gas generator. The resin-made long body rotates the driving wheel. The pipe contains the resin-made long body. The gas generator supplies an operation gas into the pipe. The resin-made long body discharged from the pipe is configured to rotate the driving wheel while the resin-made long body is wound around the driving wheel.

### CROSS-REFERENCE TO RELATED APPLICATIONS

This application claims the benefit of Japanese Patent Application No. 2016-157180, filed on Aug. 10, 2016, the entire contents of which are hereby incorporated by reference, the same as if set forth at length, the entire of which are incorporated herein by reference.

### TECHNICAL FIELD

The present invention relates to a pretensioner, a retractor and a seat belt device, and particularly to a pretensioner, a retractor, and a seat belt device which use a resin-made long body as a power transmission member.

### BACKGROUND ART

In a vehicle such as an automobile, generally, a seat belt device which restrains an occupant is provided in a seat including a seating part on which the occupant sits and a backrest part positioned on the back surface side of the occupant. Such a seat belt device includes a webbing which restrains the occupant, a retractor which performs winding of the webbing, a guide anchor which is provided in a vehicle body and guides the webbing, a belt anchor which fixes the webbing in the vehicle body, a buckle which is disposed on the side surface of the seat, and a tongue which is disposed in the webbing. When the tongue is fitted into the buckle, the occupant is restrained in the seat by the webbing.

In the retractor, a pretensioner which removes the looseness of the webbing during an emergency such as a collision of the vehicle is disposed in many cases. In addition, recently, it is considered that a resin column-shaped rack (resin rod) is used as a moving member (power transmission member) which rotates a spool at the time of the emergency (for example, JP-A-2014-201156 and WO 2014/194993 A).

### SUMMARY OF INVENTION

In the pretensioner described in JP-A-2014-201156, the movement energy of the moving member (power transmission member) which rotates the spool is reduced in a second area and an engaging part, and finally, the movement is stopped by engaging the moving member (power transmission member) in the engaging part. In such a pretensioner, the resin column-shaped rack (resin rod) is engaged in a driving wheel (pinion). Therefore, when the movement of the resin column-shaped rack (resin rod) is stopped, the rotation of the spool is stopped, and the winding of the webbing is stopped.

Therefore, in order to secure a certain winding amount of the webbing, it is necessary to make the resin column-shaped rack (resin rod) long, and it is necessary to form a place (containing part) where the resin column-shaped rack (resin rod) is escaped after rotating the driving wheel (pinion). That is, the maximum winding amount of the webbing depends on the length of the resin column-shaped rack (resin rod) and the capacitance of the containing part thereof.

As a result, the conventional pretensioner has a problem that the pretensioner becomes enlarged in order to increase the maximum winding amount of the webbing, and the maximum winding amount of the webbing becomes small in order to miniaturize the pretensioner.

In the pretensioner described in WO 2014/194993 A, it is necessary that the resin-made long body which rotates the driving wheel is peeled off from the driving wheel, and it is expected that the resin-made long body can be hardly operated smoothly as described in WO 2014/194993 A. In addition, the resin-made long body is peeled off to be detoured and is engaged in the driving wheel again. However, it is expected that an approaching angle with respect to the tangential direction of the driving wheel is large, and the resin-made long body can be hardly engaged in the driving wheel while the rotation of the driving wheel is maintained.

In the pretensioner described in WO 2014/194993 A, the resin-made long body is detoured, and thus there is a problem that the pretensioner is enlarged similarly to that of JP-A-2014-201156.

The present embodiment has been made in consideration of the above-described problems, and an object thereof is to provide a pretensioner, a retractor, and a seat belt device in which a maximum winding amount of a webbing is increased while an enlargement of the pretensioner is suppressed.

A pretensioner includes a driving wheel and a power transmission unit. A spool is disposed to be rotatable in the driving wheel. The spool winds a webbing which restrains an occupant. The power transmission unit transmits power to the driving wheel during an emergency.

The power transmission unit includes a resin-made long body, a pipe and a gas generator. The resin-made long body rotates the driving wheel. The pipe contains the resin-made long body. The gas generator supplies an operation gas into the pipe. The resin-made long body discharged from the pipe is configured to rotate the driving wheel while the resin-made long body is wound around the driving wheel.

A retractor includes a spool and a pretensioner. The spool winds a webbing which restrains an occupant. The pretensioner removes a looseness by winding the webbing during an emergency. The pretensioner includes a driving wheel and a power transmission unit. A spool is disposed to be rotatable in the driving wheel. The spool winds a webbing which restrains an occupant. The power transmission unit transmits power to the driving wheel during an emergency. The power transmission unit includes a resin-made long body, a pipe and a gas generator. The resin-made long body rotates the driving wheel. The pipe contains the resin-made long body. The gas generator supplies an operation gas into the pipe. The resin-made long body discharged from the pipe is configured to rotate the driving wheel while the resin-made long body is wound around the driving wheel.

A seat belt device includes a webbing, a retractor, a belt anchor, a buckle and a tongue. The webbing restrains an occupant. The retractor winds the webbing. The belt anchor fixes the webbing in a vehicle body. The buckle is disposed on a side surface of the seat. The tongue is disposed in the webbing. The retractor includes a spool which winds the webbing, and a pretensioner which removes a looseness by winding the webbing during an emergency. The pretensioner includes a driving wheel and a power transmission unit. A spool is disposed to be rotatable in the driving wheel. The spool winds a webbing which restrains an occupant. The power transmission unit transmits power to the driving wheel during an emergency. The power transmission unit includes a resin-made long body, a pipe and a gas generator. The resin-made long body rotates the driving wheel. The pipe contains the resin-made long body. The gas generator supplies an operation gas into the pipe. The resin-made long body discharged from the pipe is configured to rotate the driving wheel while the resin-made long body is wound around the driving wheel.

In the pretensioner, the retractor and the seat belt described above, the resin-made long body may have a length shorter than an outer circumferential length of the driving wheel, and may have at least a length longer than a half of the outer circumferential length.

The pretensioner may include a cover member which covers an outer circumference of the driving wheel. The cover member may be configured to form a passage of the resin-made long body.

In the pretensioner, the retractor, and the seat belt device according to the above-described present embodiment, the driving wheel is configured to be rotated while the resin-made long body is wound around the driving wheel. Therefore, the driving wheel can be continuously rotated by the inertial force of the resin-made long body until the resin-made long body becomes still, and the maximum winding amount of the webbing can be increased.

Since a state where the resin-made long body is wound around the driving wheel is held, it is unnecessary to secure a space to contain the resin-made long body peeled off from the driving wheel, and it is possible to suppress the enlargement of the pretensioner.

### BRIEF DESCRIPTION OF DRAWINGS

FIG. 1 is a developed view illustrating components of a retractor according to one embodiment of the present embodiment;

FIGS. 2A and 2B are partially sectional views of a pretensioner illustrated in FIG. 1. FIG. 2A illustrates an initial state, and FIG. 2B illustrates an operation-proceeding state (first rotation);

FIGS. 3A and 3B are partially sectional views of the pretensioner illustrated in FIG. 1. FIG. 3A illustrates an operation-ending state (second rotation), and FIG. 3B illustrates a modification;

FIG. 4 is a diagram for explaining an effect of the pretensioner illustrated in FIG. 1; and

FIG. 5 is an entire configuration view illustrating a seat belt device according to the embodiment of the present embodiment.

### DESCRIPTION OF EMBODIMENTS

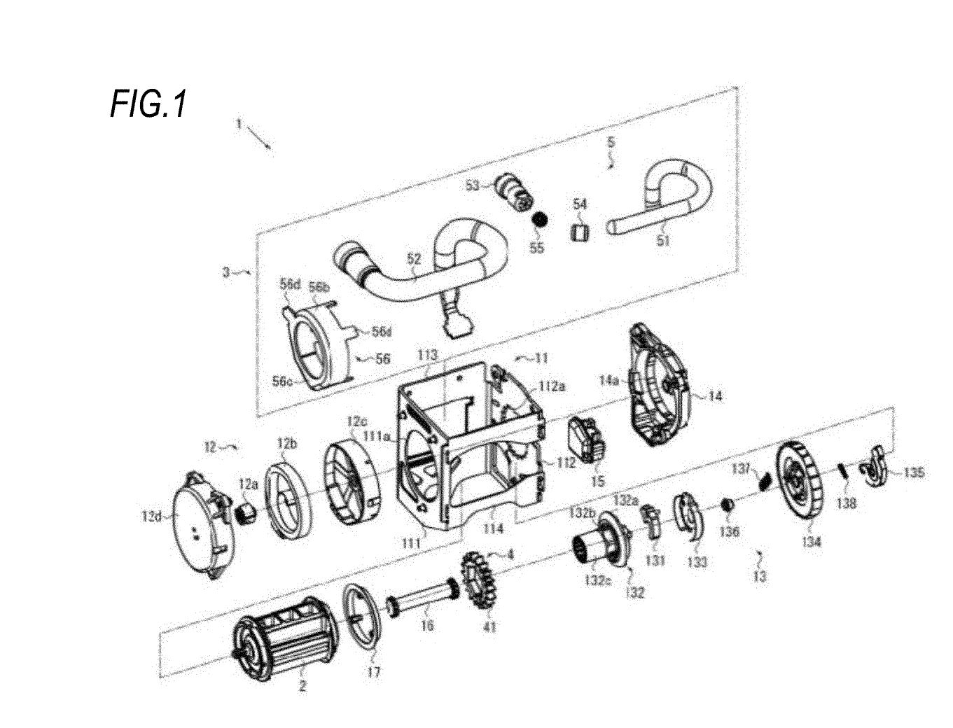

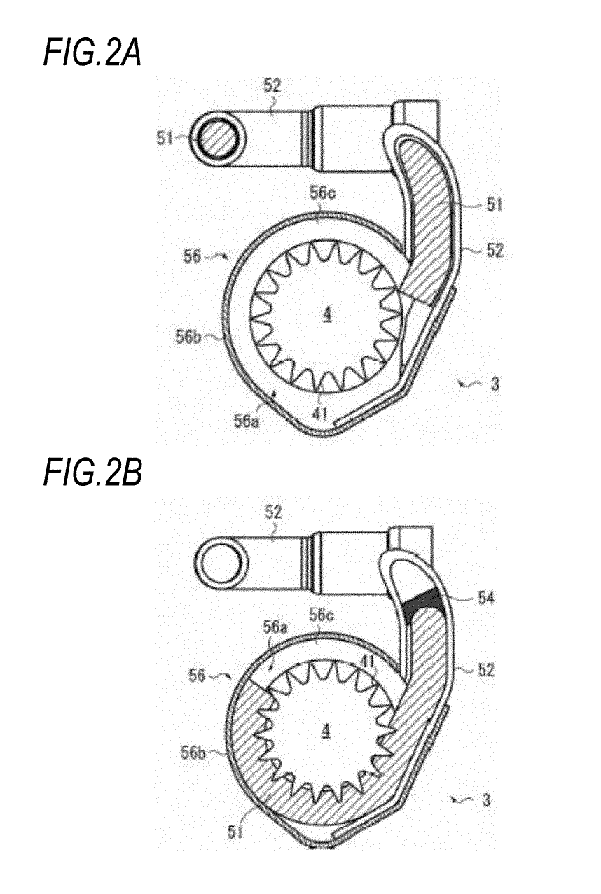

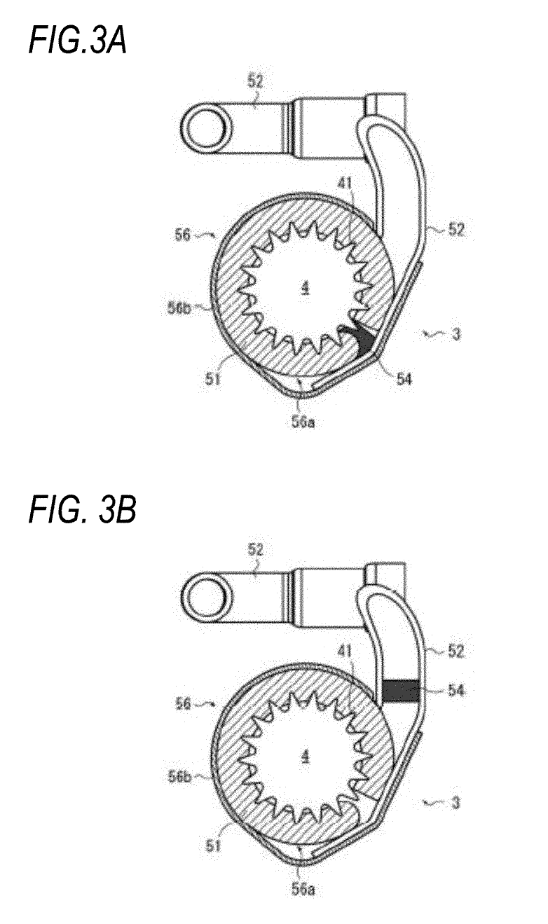

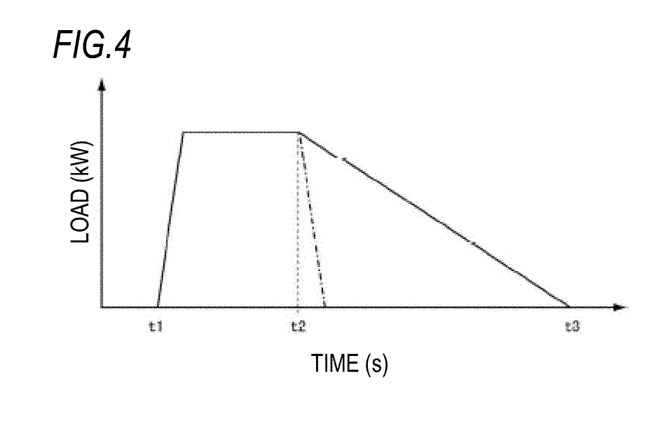

Hereinafter, the embodiment of the present embodiment will be described with reference to FIGS. 1 to 4. Herein, FIG. 1 is a developed view illustrating components of a retractor according to the embodiment of the present embodiment. FIGS. 2A and 2B are sectional views partially illustrating the pretensioner illustrated in FIG. 1. FIG. 2A illustrates an initial state, and FIG. 2B illustrates an operation-proceeding state (first rotation). FIGS. 3A and 3B are sectional views partially illustrating the pretensioner illustrated in FIG. 1. FIG. 3A illustrates an operation-ending state (second rotation), and FIG. 3B illustrates a modification. FIG. 4 is a diagram for explaining an effect of the pretensioner illustrated in FIG. 1.

For example, as illustrated in FIGS. 1 to 3B, the retractor 1 according to the embodiment of the present embodiment includes a spool 2 which performs winding of a webbing which restrains an occupant, and a pretensioner 3 which removes a looseness by winding the webbing during an emergency. The pretensioner 3 includes a driving wheel 4 which is disposed such that the spool 2 is rotatable, and a power transmission unit 5 which transmits a power to the driving wheel 4 during the emergency. The power transmission unit 5 includes a resin-made long body 51 which rotates the driving wheel 4, a pipe 52 which contains the resin-made long body 51, and a gas generator 53 which supplies an operation gas into the pipe 52. The resin-made long body 51 discharged from the pipe 52 is configured to rotate the driving wheel 4 while the resin-made long body is wound around the driving wheel 4.

The spool 2 is a winding drum which winds the webbing, and is rotatably contained in the base frame 11 forming a frame of the retractor 1. For example, the base frame 11 has a pair of end surfaces 111 and 112 which confront each other, and a side surface 113 which connects the end surfaces. The base frame 11 may have a tie plate 114 which confronts the side surface 113 and is connected with the end surfaces 111 and 112. In addition, for example, a spring unit 12 is disposed on the end surface 111, and the pretensioner 3 and a lock mechanism 13 are disposed on the end surface 112. Incidentally, the arrangement of the spring unit 12, the pretensioner 3, the lock mechanism 13, and the like is not limited to the illustrated one.

An opening 111a through which the spool 2 is inserted is formed in the end surface 111 of the base frame 11, and an opening 112a which has internal teeth engageable with a pawl 131 of the lock mechanism 13 is formed in the end surface 112 of the base frame 11. In addition, a portion (for example, the driving wheel 4 and the cover member 56) of the pretensioner 3 is disposed on the inside of the end surface 112 of the base frame 11. In addition, the lock mechanism 13 is disposed on the outside of the end surface 112 of the base frame 11, and the lock mechanism 13 is contained in the retainer cover 14.

A vehicle sensor 15 which detects the sharp deceleration of the vehicle body may be disposed in the retainer cover 14. For example, the vehicle sensor 15 has a spherical mass body, and a sensor lever which is swung by the movement of the mass body. The vehicle sensor 15 may be fitted into the opening formed in the end surface 112 of the base frame 11.

The spool 2 has a hollow in the central portion, and a torsion bar 16 forming an axial center is inserted thereto. In addition, one end of the spool 2 is connected with the spring core 12a of the spring unit 12. The spring unit 12 includes a flat spiral spring 12b connected with the spring core 12a, a spring case 12c which contains the flat spiral spring 12b, and a spring cover 12d which covers those components. The spring core 12a is rotatably supported by the spring case 12c and the spring cover 12d.

Incidentally, a configuration in which a winding force is applied to the spool 2 is not limited to the illustrated configuration. In addition, in FIG. 1, the reference numeral 17 denotes a shaft bearing.

The other end of the torsion bar 16 is connected with a locking base 132 of the lock mechanism 13. As described later, the locking base 132 is configured to be engaged in the base frame 11, and can switch the torsion bar 16 between a rotating state and a non-rotating state. Therefore, in a state where the lock mechanism 13 is operated (a state where the locking base 132 is engaged with the base frame 11), even in a case where the load is applied in a direction to draw the webbing, the spool 2 can be held in the non-rotating state until a load of a threshold or more is generated in the torsion bar 16. Further, in the case where the load of the threshold or more is generated in the torsion bar 16, the spool 2 relatively generates a rotational movement when the torsion bar 16 is twisted, and the webbing is drawn.

The lock mechanism 13 includes the locking base 132 connected with the end of the torsion bar 16, the pawl 131 which is movably disposed in the locking base 132, a cover plate 133 for regulating an axial movement of the pawl 131, a lock gear 134 which is rotatably disposed on the outside of the locking base 132, and a flywheel 135 which is swingably disposed in the lock gear 134.

Incidentally, the lock mechanism 13 is not limited to the illustrated configuration, and various configurations having known from the past may be arbitrarily selected to be used. In addition, in FIG. 1, the reference numeral 136 denotes a bearing cap, the reference numeral 137 denotes a pawl spring, and the reference numeral 138 denotes a hook spring.

The locking base 132 has a circular disc part 132a, a polygonal columnar driving wheel supporting part 132b which is formed on the spool 2 side of the disc part 132a and supports the driving wheel 4, and a torsion bar supporting part 132c into which the other end of the torsion bar 16 is inserted. In the illustrated embodiment, the spool 2, the torsion bar 16, the locking base 132, and the like are disposed to be coaxial with each other, so as to form a rotational axis of the spool 2.

Incidentally, herein, the description has been given about a case where the driving wheel 4 is fixed in the locking base 132, but the present embodiment is not limited to such a configuration. For example, the rotation of the driving wheel 4 may be transmitted to the spool 2 through a pinion gear by inserting the pinion gear connected with the spool 2 into the driving wheel 4, and engaging the internal teeth of the driving wheel 4 with the external teeth of the pinion gear as needed.

According to the lock mechanism 13 having the above-described configuration, in a case where the webbing is drawn at a rate higher than a normal drawing rate, that is, in a case where the drawing acceleration of the webbing exceeds a predetermined threshold, the flywheel 135 is swung to be engaged with the internal teeth 14a of the retainer cover 14, so as to regulate the rotation of the lock gear 134. In addition, in a case where the vehicle sensor 15 is operated, the sensor lever is engaged with the external teeth of the lock gear 134, so as to regulate the rotation of the lock gear 134.

Further, when the rotation of the lock gear 134 is regulated, a relative rotation is generated between the locking base 132 and the lock gear 134, and the pawl 131 is moved outward in the radial direction according to the relative rotation, so that the tip of the pawl 131 is engaged in the internal teeth formed in the opening 112a of the base frame 11 (that is, the locking base 132 is engaged with the base frame 11 through the pawl 131). As a result, the rotation of the locking base 132 is regulated, and the rotation of the spool 2 also is regulated. Therefore, the drawing of the webbing is locked.

Incidentally, at a normal time (a case where the drawing acceleration of the webbing is equal to or less than a predetermined threshold), the lock mechanism 13 is not operated, and the locking base 132 and the lock gear 134 are rotated together according to the rotation of the spool 2. Therefore, at the normal time, since the locking base 132 and the lock gear 134 are not relatively rotated, the pawl 131 is configured to maintain the state where the pawl retracts to a position not to interfere with the internal teeth formed in the opening 112a of the base frame 11.

The pretensioner 3 is a component which rotates the driving wheel 4 by the power transmission unit 5 during the emergency such as the collision of the vehicle so as to remove the looseness of the webbing. Similarly to the conventional power transmission unit 5, the power transmission unit 5 has the resin-made long body 51 as a power transmission member, the pipe 52, the gas generator 53, a piston 54, a stopper spring 55, and the cover member 56.

The resin-made long body 51 is a resin-made long member (so-called resin rod) which is plastically deformable. Herein, the “long body” means an object of which the length is sufficiently long (for example, at least several times to several ten times) with respect to a diameter. For example, the resin-made long body 51 has a length which is shorter than the outer circumferential length of the driving wheel 4. The outer circumferential length of the driving wheel 4 may be defined by a tip position of teeth 41 of the driving wheel 4, may be defined by an intermediate position (for example, a position of half the height of the teeth 41) of the teeth 41 of the driving wheel 4, or may be defined by a root position of the teeth 41 of the driving wheel 4.

The resin-made long body 51 is extruded by a gas pressure when the rear end thereof is in the state of being contained in the pipe 52, and thus a certain load can be supplied to the driving wheel 4. Therefore, preferably, the resin-made long body 51 has a certain length or more, and preferably has a length equal to or more than at least half (50%) of the outer circumferential length of the driving wheel 4.

In a case where it is demanded that the resin-made long body 51 is extruded over a longer time, the length of the resin-made long body 51 may be set to be equal to or more than a 75% length of the outer circumferential length of the driving wheel 4, may be set to be equal to or more than a 90% length thereof, or may be set to be equal to or more than a 95% length thereof. However, the length of the resin-made long body 51 is set not to exceed a 100% length of the outer circumferential length of the driving wheel 4.

Incidentally, in the illustrated embodiment, the resin-made long body 51 is provided as a single molding body. However, the resin-made long body 51 is not necessarily one body, and may be divided to a plurality of bodies.

The pipe 52 is a pressure vessel which forms an injection cylinder of the resin-made long body 51. It is necessary that the pipe 52 has a certain length, and thus the pipe 52 is bent to be disposed along the side surface of the base frame 11. The gas generator 53 is mounted in the rear end of the pipe 52. The piston 54 receives the operation gas supplied from the gas generator 53, and is formed to be slid while sealing the inside surface of the pipe 52. The stopper spring 55 is a component which forms a space for supplying the operation gas to between the gas generator 53 and the piston 54.

As illustrated in FIGS. 2A and 2B, the cover member 56 is configured to cover the outer circumference of the driving wheel 4, and to form a passage 56a of the resin-made long body 51. Specifically, the cover member 56 includes a side surface 56b which covers the outer circumference of the driving wheel 4, a top plate 56c which regulates the movement of the resin-made long body 51 in an axial direction of the spool 2, and a plurality of taps 56d which are engaged with the base frame 11. The passage 56a is configured by the space formed among the cover member 56 (the side surface 56b and the top plate 56c), the driving wheel 4, and the base frame 11 (end surface 112).

As illustrated in FIG. 1, the side surface 56b has a substantially cylindrical shape. The engaging amount of the resin-made long body 51 into the driving wheel 4 can be adjusted by adjusting a radial size of the side surface 56b. In addition, the top plate 56c has a substantially ring shape, and components configuring a shaft system of the pretensioner 3 are inserted into the opening of the central portion.

As illustrated in FIG. 2A, the pipe 52 is connected with the side surface 56b of the cover member 56, and the resin-made long body 51 discharged from the pipe 52 is moved along the inside surface of the side surface 56b of the cover member 56. In addition, the side surface 56b of the cover member 56 is formed such that the resin-made long body 51 passing through the passage 56a is guided to an outlet of the pipe 52 again.

Herein, the description will be described about the operation of the pretensioner 3. As illustrated in FIG. 2A, in an initial state, the resin-made long body 51 is contained in the pipe 52. At that time, the tip of the resin-made long body 51 is disposed in a position not to interfere with the driving wheel 4 in the outlet of the pipe 52.

During the emergency such as the collision of the vehicle, the operation gas of high pressure is supplied from the gas generator 53 into the pipe 52. The operation gas presses the piston 54 to be slid in the pipe 52. The piston 54 presses the resin-made long body 51 to be moved in the pipe 52. The resin-made long body 51 extruded from the pipe 52 moves toward the teeth 41 formed in the outer circumference of the driving wheel 4. As illustrated in FIG. 2B, the resin-made long body 51 colliding with the teeth 41 is engaged with the teeth 41 while being deformed plastically, and moves along the passage 56a while rotating the driving wheel 4.

In this embodiment, the resin-made long body 51 is formed to be shorter than the outer circumferential length of the driving wheel 4, and thus, finally, the entire length of the resin-made long body 51 is extruded in the passage 56a. Further, the resin-made long body 51 is guided to the outlet of the pipe 52 by the side surface 56b of the cover member 56, and enters into the second rotation while being wound around the driving wheel 4 as illustrated in FIG. 3A.

At that time, the piston 54 may also be extruded to the passage 56a together with the resin-made long body 51, and only the piston 54 may stay in the pipe 52 as illustrated in a modification of FIG. 3B.

Herein, a horizontal axis of FIG. 4 indicates a time (s), and a vertical axis indicates a load (kN) generated in the driving wheel 4. As indicated by a solid line in FIG. 4, in the above-described pretensioner 3, when the operation starts at a time t1, a certain load is generated in the driving wheel 4. When the entire amount of the resin-made long body 51 is extruded from the pipe 52 at a time t2, a pressure by the operation gas is not applied any longer, and thus the load which is applied to the driving wheel 4 by the inertial force of the resin-made long body 51 decreases gradually to balance with the tension of the webbing until a time t3.

With respect thereto, in the conventional pretensioner in which a portion of the resin-made long body is engaged with the driving wheel to be rotated, and then the resin-made long body collides with the containing part so that the movement stops, the resin-made long body collides with the containing part at the time t2 as indicated by an one-dot chain line of FIG. 4, so that the movement of the resin-made long body stops directly, and thus the load generated in the driving wheel 4 is also reduced directly.

Therefore, as illustrated in FIG. 4, in the pretensioner 3 according to this embodiment, the driving wheel 4 can be rotated over a time longer than that in the conventional pretensioner, so as to increase a rotating amount of the driving wheel 4.

That is, in the above-described pretensioner 3 and retractor 1 according to this embodiment, the driving wheel 4 is configured to be rotated while the resin-made long body 51 is wound around the driving wheel 4. Therefore, the driving wheel 4 can be continuously rotated by the inertial force of the resin-made long body 51 until the resin-made long body 51 becomes still, and the maximum winding amount of the webbing can be increased.

The resin-made long body 51 is held in the state of being wound around the driving wheel 4. Therefore, it is unnecessary to secure the space which contains the resin-made long body 51 peeled off from the driving wheel 4, and it is possible to suppress the enlargement of the pretensioner 3 and the retractor 1. In addition, it is unnecessary to peel off the resin-made long body 51 wound around the driving wheel 4 from the driving wheel 4, and thus it is possible to secure the smooth operation of the resin-made long body 51.

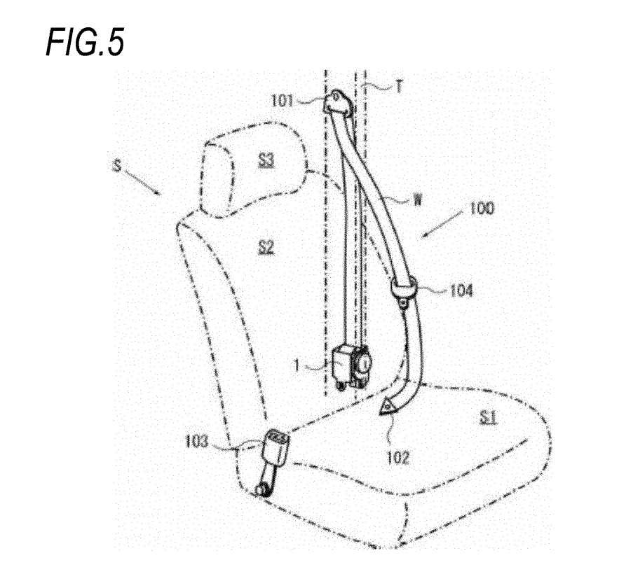

Next, a seat belt device according to the embodiment of the present embodiment will be described with reference to FIG. 5. Herein, FIG. 5 is an entire configuration view illustrating the seat belt device according to the embodiment of the present embodiment. Incidentally, in FIG. 5, for the convenience of description, the components other than the seat belt device are illustrated by one-dot chain lines. In addition, a seat belt device 100 illustrated in FIG. 5 indicates a seat belt device which is disposed on a front seat (a driver seat or a passenger seat) of the vehicle.

The seat belt device 100 illustrated in FIG. 5 according to this embodiment includes a webbing W which restrains the occupant, the retractor 1 which performs winding of the webbing W, a guide anchor 101 which is provided in the vehicle body to guide the webbing W, a belt anchor 102 which fixes the webbing W in the vehicle body, a buckle 103 which is disposed on the side surface of the seat S, and a tongue 104 which is disposed in the webbing W. For example, the retractor 1 has the configuration illustrated in FIG. 1.

For example, the seat S includes a seating part S1 on which the occupant sits, a backrest portion S2 which is positioned on the back surface of the occupant, and a headrest S3 which supports the head of the occupant. For example, the retractor 1 is built in a B pillar T of the vehicle body. In addition, generally, in many cases, the buckle 103 is disposed on the side surface of the seating part S1, and the belt anchor 102 is disposed on the lower surface of the seating part S1. In addition, in many cases, the guide anchor 101 is disposed in the B pillar T. Further, in the webbing W, the one end is connected with the belt anchor 102, and the other end is connected with the retractor 1 through the guide anchor 101.

Therefore, in a case where the tongue 104 is fitted into the buckle 103, the webbing W is drawn from the retractor 1 while sliding along an insertion hole of the guide anchor 101. In addition, in a case where the occupant fastens the seat belt, or a case where the seat belt is released at the time of getting-off, the webbing W is wound by the effect of the spring unit 12 of the retractor 1 until a certain load is applied.

The present embodiment is not limited to the above-described embodiment. For example, the present embodiment may be applied to a seat belt device used in a rear seat of the vehicle, and to a seat belt device used in other vehicles in addition to the vehicle. The present embodiment may be modified variously without departing from the spirit and scope of the embodiment.

What is claimed is:

1. A pretensioner comprising:
a driving wheel in which a spool is disposed to be rotatable, the spool winding a webbing which restrains an occupant; and
a power transmission unit that transmits power to the driving wheel during an emergency, wherein
the power transmission unit includes:
a resin-made long body that rotates the driving wheel;
a pipe that contains the resin-made long body; and
a gas generator that supplies an operation gas into the pipe, and
the resin-made long body discharged from the pipe is configured to rotate the driving wheel while the resin-made long body is wound around the driving wheel.

2. The pretensioner according to claim 1, wherein
the resin-made long body has a length shorter than an outer circumferential length of the driving wheel, and has at least a length longer than a half of the outer circumferential length.

3. The pretensioner according to claim 1, further comprising:
a cover member that covers an outer circumference of the driving wheel, wherein
the cover member is configured to form a passage of the resin-made long body.

4. A retractor comprising:
a spool that winds a webbing which restrains an occupant; and
a pretensioner that removes a looseness by winding the webbing during an emergency, wherein
the pretensioner is the pretensioner according to claim 1.

5. A seat belt device comprising:
a webbing that restrains an occupant;
a retractor that winds the webbing;
a belt anchor that fixes the webbing in a vehicle body;
a buckle that is disposed on a side surface of the seat; and
a tongue that is disposed in the webbing, wherein
the retractor includes a spool which winds the webbing, and a pretensioner which removes a looseness by winding the webbing during an emergency, and
the pretensioner is the pretensioner according to claim 1.
